(19) United States
(12) Patent Application Publication
(10) Pub. No.: US 2003/0217841 A1
(43) Pub. Date: Nov. 27, 2003

(54) Instrument thermal regulator

(76) Inventors: Paul E. Bussard, Santa Rosa, CA (US); Gabriel Todd Manville, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/154,072

(22) Filed: May 23, 2002

(51) Int. Cl. F24F 7/00; F24H 3/00; F24F 11/00; F24F 13/06; F24F 13/08; F25B 29/00; G05D 23/00

(52) U.S. Cl. 165/260; 165/289; 165/291; 165/47; 237/46; 237/2 A; 454/258

(57) ABSTRACT

A thermal regulator stabilizes the temperature within an internal cavity of an instrument. The thermal regulator includes a circulator that draws ambient medium surrounding the instrument and recirculated medium within the internal cavity, into a duct. The circulator forms a mixture of the drawn ambient medium and recirculated medium. An adjustable heater intercepts the mixture and controls the temperature of the mixture to be within a temperature range that is less than a temperature range of the ambient medium in which the instrument is surrounded.

### BACKGROUND OF THE INVENTION

Performance characteristics of many types of instruments are temperature dependent due to temperature sensitive components or systems included in the instruments. For example, the accuracy of an instrument that measures optical group delay is influenced by temperature variations of signal transmission paths, modulators, converters and other components included in the instrument. To accommodate for these temperature sensitive components, instrument manufacturers typically guarantee an instrument's compliance with a specified performance characteristic only if the ambient medium in which the instrument operates does not vary outside a designated, limited temperature range. However, since instruments are operated in a variety of settings, such as instrument racks in automated test environments or field testing environments, it is not always feasible to limit the temperature of the ambient medium to be within the designated temperature range. Accordingly, there is a need to reduce the influence that temperature variations of the ambient medium have on the performance characteristics of the instrument.

A thermal regulator constructed according to the embodiment of the present invention reduces the effect of a temperature-varying ambient medium on performance characteristics of an instrument by stabilizing the temperature within an internal cavity of an instrument. The thermal regulator includes a circulator that draws ambient medium surrounding the instrument and recirculated medium within the internal cavity, into a duct. The circulator forms a mixture of the drawn ambient medium and recirculated medium. An adjustable heater intercepts the mixture and controls the temperature of the mixture to be within a temperature range that is less than a temperature range of the ambient medium in which the instrument is surrounded.

### BRIEF DESCRIPTION OF THE DRAWINGS

FIGS. 1A-1B show alternative views of a thermal regulator constructed according to the embodiment of the present invention.

FIG. 2 shows a block diagram of a control loop including the thermal regulator of FIGS. 1A-1B.

FIGS. 3A-3B show adjustable power dissipation profiles of a heater included in the thermal regulator.

FIG. 4 is a temperature plot for the thermal regulator.

### DETAILED DESCRIPTION OF THE EMBODIMENT

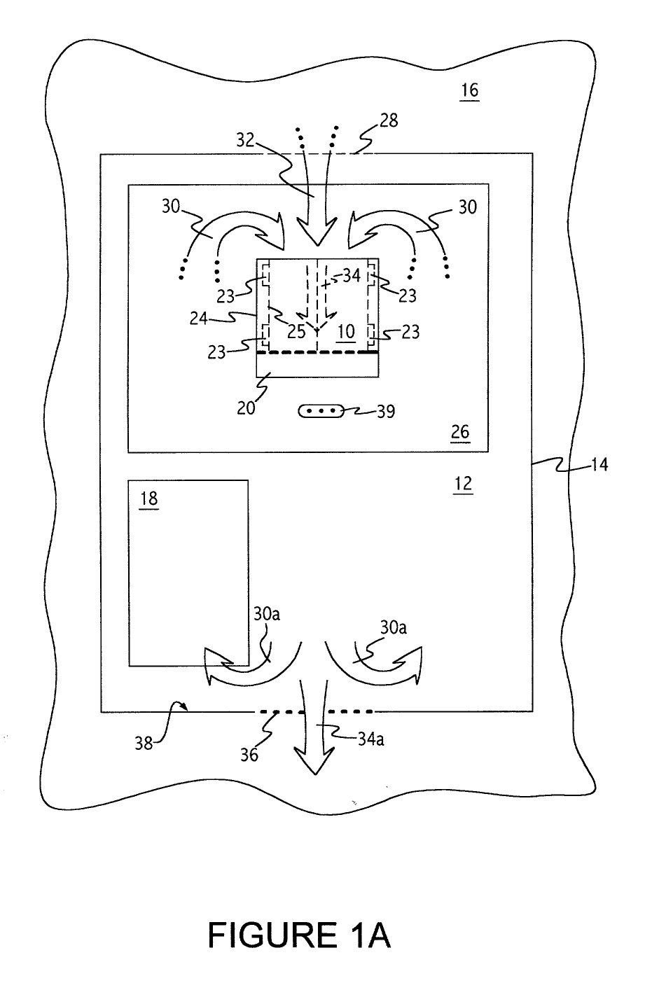

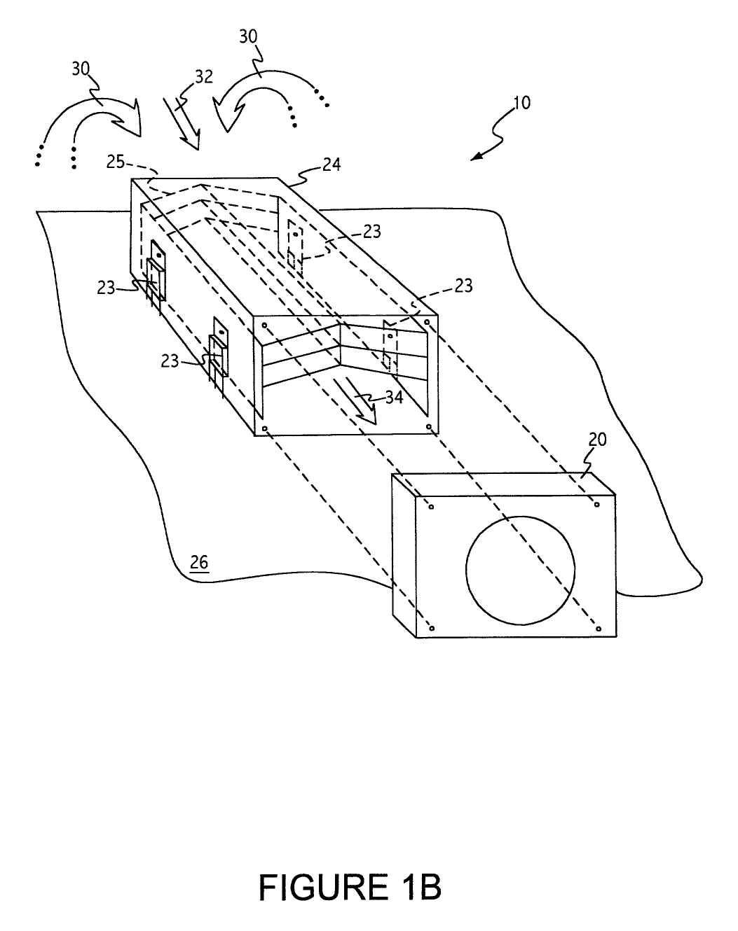

FIGS. 1A-1B show alternative views of the thermal regulator 10 constructed according to the embodiment of the present invention. The thermal regulator 10 stabilizes temperature within an internal cavity 12 of an instrument 14, even in the presence of a temperature-varying ambient medium 16 surrounding the instrument 14. In one example, the thermal regulator 10 is included in an optical instrument 14 with an internal group delay measurement system that has temperature-dependent measurement accuracy. However, the thermal regulator 10 is also suitable for inclusion in other types of optical or electrical instruments 14, especially those having internal components or systems 18 with performance characteristics that are temperature dependent. The ambient medium 16 surrounding the instrument 14 is typically air, but is alternatively another gas or liquid within which the instrument 14 is suitably operated.

The thermal regulator 10, including a circulator 20, a heater and a duct 24, is mounted on a circuit board 26, chassis, panel or other part of the instrument 14. In the example shown in FIGS. 1A-1B, the thermal regulator 10 is mounted on a circuit board 26 within the internal cavity 12 of the instrument 14.

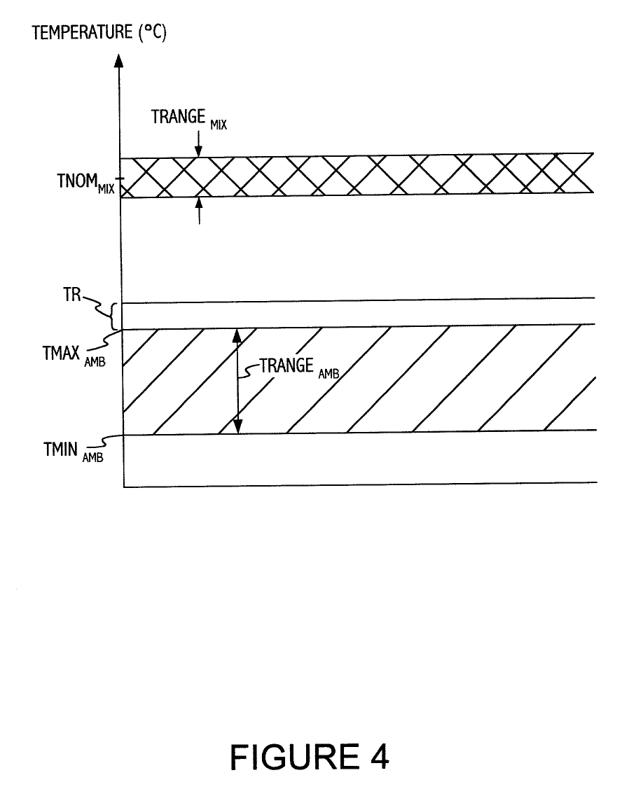

The circulator 20 draws the ambient medium 16 at a designated flow rate through an intake 28 of the instrument 14 and into the duct 24. The circulator 20 also draws a recirculated medium 30 that is within the internal cavity 12 of the instrument 14 into the duct 24, forming a mixture 34 of drawn ambient medium 32 and recirculated medium 30. The heater includes one or more heating elements 23 that intercept the mixture 34 of the drawn ambient medium 32 and the drawn recirculated medium 30, and control the temperature of the mixture 34. The temperature of the mixture 34 is controlled to be sufficiently high to accommodate for a maximum ambient temperature TMAX_{AMB} specified for the ambient medium 16 and a temperature rise TR induced by power dissipation of the components or systems 18 within the instrument 14, as shown in FIG. 4. Typically, the temperature of the ambient medium 16 surrounding the instrument 14 is specified to be within a temperature range TRANGE_{AMB} between a minimum ambient temperature TMIN_{AMB}, such as 20 degrees centigrade for example, and the maximum ambient temperature TMAX_{AMB}, such as 30 degrees centigrade for example. In an example where the power dissipation within the instrument 14 causes a temperature rise TR, such as 3 degrees centigrade for example, adjusting the mixture 34 to have a nominal temperature TNOM_{MIX} that is at least as high as the maximum ambient temperature TMAX_{AMB} plus the temperature rise TR, or 33 degrees centigrade in this example, is sufficient. Since reliability of components or systems 18 within the instrument 14 generally decreases as the temperature within the internal cavity 12 of the instrument 14 increases, the nominal temperature TNOM_{MIX} of the mixture 34 is set high enough to accommodate for the maximum ambient temperature TMAX_{AMB} specified for the ambient medium 16 and the induced temperature rise TR, but not high enough to significantly decrease the reliability of the components or systems 18 within the instrument 14.

Once the heating elements 23 of the heater control the temperature of the mixture 34, the mixture 34 is distributed about the internal cavity 12 of the instrument 14 via the action of the circulator 20. Of the mixture 34 that is drawn through the duct 24, a portion 30a is recirculated through the internal cavity 12 and a portion 34a is vented out of the instrument 14 at the predetermined flow rate through an exhaust 36. The exhaust 36, typically located on a panel 38, such as a front panel, of the instrument 14, includes one or more openings or holes. The distribution of the one or more openings of the exhaust 36 is adjusted, either empirically or based on flow analysis, to establish the portion 34a of the mixture 34 that is vented out of the instrument 14 relative to the portion 30a of the mixture 34 that is recirculated through the internal cavity 12 of the instrument 14. The portion 34a of the mixture 34 that is vented out of the instrument 14 generally increases as the one or more openings that form the exhaust 36 are increased or aligned in the flow of the mixture 34 from the duct 24, while locating the one or more openings on the panel 38 of the instrument 14 remote from the flow of the mixture 34 from the duct 24 generally increases the portion 30a of the mixture 34 that is recirculated through the internal cavity 12.

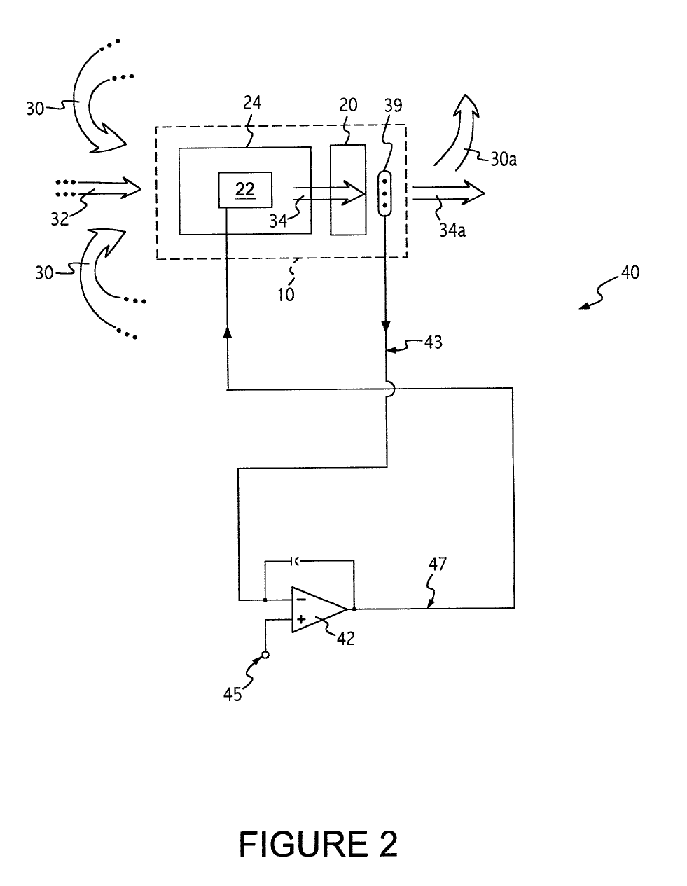

The thermal regulator 10 optionally includes a probe 39 positioned to sense the temperature of the mixture 34 of drawn ambient medium 32 and recirculated medium 30. Thermocouples, semiconductor devices, thermometers, transducers and other types of temperature sensors are known in the art and are suitable for the probe 39. The thermal regulator 10 and the probe 39 are optionally integrated within a control loop 40 as shown in the block diagram of FIG. 2. Control loops typically include a gain block 42, such as a differential amplifier, that receives a reference signal 45 and a sensor signal 43 from the probe 39, and provides an error signal 47, responsive to the difference between the sensor signal 43 and the reference signal 45, that drives the heater 22. Feedback action of the control loop 40 drives the heater 22 to reduce the error signal 47 until the control loop 40 is in the balanced state. The reference signal 45 is chosen so that in the balanced state, the temperature of the mixture 34 is set to a nominal temperature TNOM_{MIX}. Control loops 40 implemented in hardware, software, or combinations of hardware and software, are known in the art and the thermal regulator 10 and probe 39 are well suited for inclusion in various types of the control loops 40. Alternatively, the thermal regulator 10 and probe 39 are coupled to a controller (not shown) to set the temperature of the mixture 34 to the nominal temperature TNOM_{MIX}. One example of a suitable controller is an OMEGA model CN4620, commercially available from OMEGA ENGINEERING, INC. Stamford, Conn., USA.

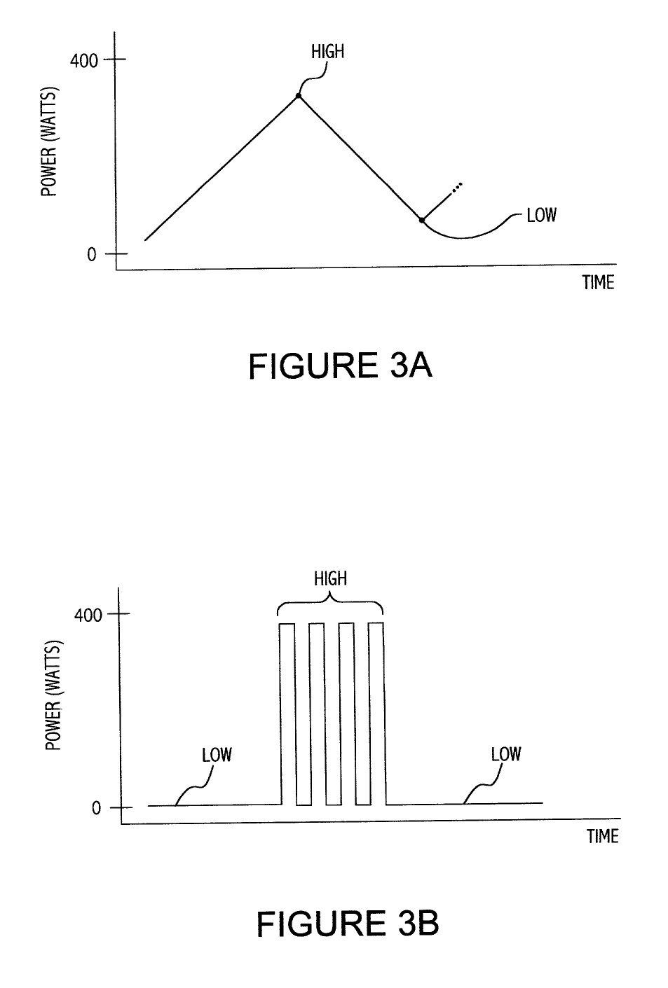

Typically, the heating elements 23 of the heater 22 are one or more resistors, transistors, or other power dissipating devices having a power dissipation or heating capacity that is adjustable. Adjustment of the power dissipation of the heating elements 23 of the heater 22 between the HIGH/LOW dissipation state or a LOW/HIGH dissipation state is achieved in a continuous manner as shown in the power dissipation profile of FIG. 3A, or in a stepped manner by varying a duty cycle when the heating elements 23 of the heater 22 are pulsed as shown in the power dissipation profile of FIG. 3B. The heating elements 23, in this example, are power transistors that are physically attached, or otherwise thermally coupled, to a heat radiator 25 of the heater 22 having a high surface area-to-volume ratio, to enable fast response time and efficient heat transfer between the heating elements 23 and the mixture 34 of drawn ambient medium 32 and recirculated medium 30. In the example shown in FIGS. 1A-1B, the heat radiator 25 of the heater 22 is integrated into the duct 24 so that the temperature of the mixture 34 is controlled as the mixture 34 is drawn through the duct 24. However, the heat radiator 25 has any other alternative position wherein temperature control of the mixture 34 is enabled.

The HIGH dissipation state the heater 22 is typically greater than the power dissipation of components or systems 18 within the instrument 14 to enable the heater 22 to slew the temperature of the mixture 34 at a high rate. In one example, the high dissipation state of the heater 22 is designed to be at least two times the power dissipation of components or systems 18 within the instruments so that the thermal regulator 10 is the dominant driving function in controlling the temperature of the mixture 34.

Adjustment of the heater 22, designating the flow rate of the drawn ambient medium 32, and defining the ratio of the recirculated medium 30 to the drawn ambient medium 32 enables the temperature of the mixture 34 to be controlled, or regulated, within a temperature range TRANGE_{MIX} about the nominal temperature TNOM_{MIX}, that is less than the temperature range TRANGE_{AMB} between the maximum ambient temperature TMAX_{AMB} and the minimum ambient temperature TMIN_{AMB}, despite changes in temperature of the ambient medium 16 and power dissipation of internal components or systems 18 within the internal cavity 12, as shown in the temperature plot of FIG. 4. Typically, the temperature range TRANGE_{MIX} is regulated to be less than ten percent of the temperature range TRANGE_{AMB} between the maximum ambient temperature TMAX_{AMB} and the minimum ambient temperature TMIN_{AMB}. In the example where the heater 22 has a power dissipation of 80 Watts in the HIGH dissipation state, the flow rate is 30 cubic feet/minute, the ratio of recirculated medium 30 to the drawn ambient medium 32 is three-to-one, and the TRANGE_{AMB} is ten degrees centigrade, the thermal regulator 10 stabilizes the temperature of the internal cavity 12 of the instrument 14 to within a temperature range TRANGE_{AMB} of two-tenths of one degree centigrade. The flow rate at which the circulator 20 draws the ambient medium 16 through the intake 28 of the instrument 14 is designated to be sufficiently high to enable the temperature of the mixture 34 of the drawn ambient medium 32 and recirculated medium 30 to be controlled about the nominal temperature TNOM_{MIX} and maintained within the temperature range TRANGE_{MIX}, even if the ambient medium 16 surrounding the instrument 14 rises to the maximum temperature TMAX_{AMB}, or if increases in power dissipation of components and systems 18 within the instrument 14 induce temperature rises TR. Under conditions of maximum ambient temperature TMAX_{AMB} and temperature rise TR, the heater 22 is typically adjusted to the LOW dissipation state and the flow rate of the drawn ambient medium 32 is sufficiently high to drive the temperature of the mixture 34 to the nominal temperature TNOM_{MIX} in a sufficiently short time. Typically, the flow rate is designated to be high enough to slew the temperature of the mixture 34 at a faster rate than the rate at which the temperature of the ambient medium 16 rises, so that temperature of the mixture 34 is maintained within the temperature range TRANGE_{MIX} in the presence of such changes in temperature of the ambient medium 16 or power dissipation of components or systems within the instrument 14.

In this example, the size and position of one or more openings or holes that form the intake 28, the proximity of the circulator 20 and duct 24 to the intake 28, or the flow capacity of the circulator 20 such as the volume of gas or liquid that the circulator 20 is capable of moving per unit of time, are manipulated to adjust the flow rate of the drawn ambient medium 32. Empirical determinations, flow analysis, or any other suitable technique for designating the flow rate for the drawn ambient medium 32 is alternatively used to adjust the flow rate.

The ratio of the recirculated medium 30 to the drawn ambient medium 32 in the mixture 34 is sufficiently high to enable the temperature of the mixture 34 to be controlled about the nominal temperature TNOM_{MIX} and maintained within the temperature range TRANGE_{MIX}, even if the ambient medium 16 surrounding the instrument 14 falls to the minimum temperature TMIN_{AMB} or if decreases in power dissipation of components and systems 18 within the instrument 14 induce no temperature rise TR. Under conditions of minimum ambient temperature TMIN_{AMB} and minimum temperature rise TR, the heater 22 is typically adjusted to the HIGH dissipation state and the ratio of recirculated medium 30 to drawn ambient medium 32 in the mixture 34 is sufficiently high to drive the temperature of the mixture 34 to the nominal temperature TNOM_{MIX} in a sufficiently short time. Typically, the ratio is defined to be high enough to enable the heater 22 to slew the temperature of the mixture 34 at a faster rate than the rate at which the temperature of the ambient medium 16 drops, so that temperature of the mixture 34 is maintained within the temperature range TRANGE_{MIX} in the presence of such changes in temperature of the ambient medium 16 or changes in power dissipation of components or systems within the instrument 14.

The ratio of recirculated medium 30 to drawn ambient medium 32 in the mixture 34 is established by cross-sectional area of the duct 24 relative to the one or more openings forming the intake 28, proximity of the duct 24 to the intake 28, physical alignment of the duct 24 relative to the intake 28, or other suitable attributes of the duct 24 and intake 28. Empirical determinations, flow analysis, or any other suitable technique for designating the flow rate for the drawn ambient medium 32 is alternatively used to adjust the flow rate.

When the ambient medium 16 is air or other type of gas, the circulator 20 is implemented using a fan, or other device capable of drawing gas through the intake 28 and drawing the recirculated medium 30 within the internal cavity 12 of the instrument 14 into the duct 24. When the ambient medium 16 is a liquid, the circulator 20 is implemented using a pump or other device capable of 15 drawing liquid through the intake 28 and drawing the recirculated medium 30 within the internal cavity 12 of the instrument 14 into the duct 24.

While the embodiment of the present invention has been illustrated in detail, it should be apparent that modifications and adaptations to this embodiment may occur to one skilled in the art without departing from the scope of the present invention as set forth in the following claims.

What is claimed is:

1. A thermal regulator for an instrument in an ambient medium, comprising:
a duct positioned within the instrument;
a circulator, drawing through the duct, the ambient medium and a recirculated medium within the instrument to form a mixture of the drawn ambient medium and the recirculated medium, and venting the mixture out of the instrument; and
a variable heater intercepting the mixture and controlling the mixture to have a nominal temperature that is sufficiently high to accommodate for a maximum temperature of the ambient medium and a temperature rise induced by at least one component within the instrument.

2. The thermal regulator of claim 1 wherein the nominal temperature of the mixture is a predetermined offset above the maximum temperature of the ambient medium plus the induced temperature rise.

3. The thermal regulator of claim 1 wherein the variable heater has a heat radiator integrated into the duct and the temperature of the mixture is controlled as the mixture is drawn through the duct.

4. The thermal regulator of claim 2 wherein the variable heater has a heat radiator integrated into the duct and the temperature of the mixture is controlled as the mixture is drawn through the duct.

5. The thermal regulator of claim 1 further comprising a probe sensing the temperature of the mixture.

6. The thermal regulator of claim 3 further comprising a probe sensing the temperature of the mixture.

7. The thermal regulator of claim 5 wherein the variable heater and the probe are included within a control loop that drives the variable heater to adjust the temperature of the mixture according to the temperature sensed by the probe.

8. The thermal regulator of claim 6 wherein the variable heater and the probe are included within a control loop that drives the variable heater to adjust the temperature of the mixture according to the temperature sensed by the probe.

9. The thermal regulator of claim 2 wherein the predetermined offset is at least three degrees centigrade.

10. The thermal regulator of claim 4 wherein the predetermined offset is at least three degrees centigrade.

11. A thermal regulator, comprising:
a duct positioned within an instrument having an internal cavity, an intake, an exhaust, and at least one internal system;
a circulator, drawing an ambient medium through the intake at a predesignated flow rate, drawing a recirculated medium within the internal cavity into the duct to form a mixture of the ambient medium and the recirculated medium in a predefined ratio, and venting the mixture out of the instrument through the exhaust at the predesignated flow rate, the ambient medium having a temperature within a first range; and
a heater, adjustable between a low dissipation state and a high dissipation state, controlling the mixture to have a nominal temperature within a second range that is less than the first range.

12. The thermal regulator of claim 11 wherein the predesignated flow rate is sufficiently high to maintain the temperature of the mixture within the second range when the temperature of the ambient medium is at a high limit of the first range and when the at least one internal system is at a maximum power dissipation.

13. The thermal regulator of claim 11 wherein the predefined ratio of the recirculated medium to the drawn ambient medium is sufficiently high to maintain the mixture within the second range when the temperature of the ambient medium is at a low limit of the first range and when the at least one internal system is at a minimum power dissipation.

14. The thermal regulator of claim 11 wherein the high dissipation state of the heater has a capacity that exceeds a maximum power dissipation of the at least one internal system.

15. The thermal regulator of claim 11 wherein the at least one internal system includes an optical group delay measurement system.
